(19) United States
(12) Patent Application Publication
(10) Pub. No.: US 2018/0207878 A1
(43) Pub. Date: Jul. 26, 2018

(54) METHOD FOR BONDING TWO DIFFERENT PLASTICS

(71) Applicant: Henkel AG & Co. KGaA, Duesseldorf (DE)

(72) Inventors: Marc Hamm, Duesseldorf (DE); Pablo Walter, Munchen (DE); Dirk Kasper, Duesseldorf (DE)

(21) Appl. No.: 15/934,007

(22) Filed: Mar. 23, 2018

Related U.S. Application Data
(63) Continuation of application No. PCT/EP2016/074657, filed on Oct. 14, 2016.

(30) Foreign Application Priority Data
Oct. 16, 2015 (EP) 15190205.3

(51) Int. Cl. B29C 65/02; B29C 65/48

(52) U.S. Cl. CPC B29C 65/02; B29C 65/4895

(57) ABSTRACT

The invention relates to a method for bonding two different plastics using a primer. The two plastics which are to be joined to each other have a weighted quadratic distance between the Hansen parameter (Rₐ)² of more 22 MPa and the primer contains a polymer which has a weighted quadratic distance between the Hansen parameter (Rₐ)² of less than 22 MPa to both of the plastics which are to be joined. The invention also relates to correspondingly bonded products.

The present invention relates to a method for welding two different plastics materials using a primer, the two plastics materials to be joined have a weighted quadratic distance of the Hansen parameter (Rₐ)² from one another of more than 22 MPa, and the primer contains a polymer that has a weighted quadratic distance of the Hansen parameter (Rₐ)² from the two plastics materials to be joined of less than 22 MPa. The present invention further relates to corresponding welded products.

Various methods are known from the prior art for interconnecting two or more substrates that consist of plastics materials, such as polyethylene (PE), polyacrylates or polyamide (PA). In this case, there are both mechanical connection options, such as locking or screwing, or adhesive bonding methods. Alternatively, plastics materials can also be welded together. Welding is a joining method for non-detachably, integrally, physically connecting plastics materials that are generally of the same type, such as PE and PE, or PA and PA. Thermoplastics of the same type are polymers that do not differ substantially in terms of their molecular structure, their melting point, their melting viscosity and their coefficient of thermal expansion, and can in principle be mixed with one another to an extent. Plastics materials of the same type are usually plastics materials having an identical polymer base and/or an identical plastics material.

A wide range of methods are known for welding together two or more plastics materials of the same kind. In this case, a wide range of welding methods can be used, such as infrared welding, infrared/friction welding or ultrasonic welding. These methods for welding plastics materials of the same kind are based on the relevant plastics materials being melted in the region of the welding zone and the materials being interconnected in said zone in an integrally bonded and frictional manner.

These welding methods work well provided that plastics materials of the same type are to be interconnected. However, as soon as two plastics materials that are not of the same type and/or that are mutually incompatible, such as polyamide and polystyrene plastics materials, are to be welded together, it is not possible to produce a permanent connection between the two substrates that has a sufficiently high mechanical strength. If an attempt is made to directly weld the two entirely different plastics materials that cannot be mixed with one another, using the welding methods known from the prior art, no or only very low strengths are achieved.

Up to now, it has been possible to interconnect corresponding different plastics materials only by means of a mechanical connection or an adhesive bonding method. The disadvantage of a mechanical connection is the complicated attachment, the punctual material stress, and the need to use an additional mechanical connection means. Furthermore, integrally bonded connections can rarely be achieved in the case of a mechanical connection. The disadvantage of an adhesive bonding method, however, is that the final strength of the connection is achieved only after a long period of time which may be up to several weeks. Furthermore, adhesively bonding low-energy surfaces usually requires laborious pretreatment of the join partners. In addition, an adhesive connection is often not indefinitely stable on account of outside weather conditions. Moreover, providing a clean adhesive connection is often complicated and time-consuming. Connection by means of a welding method is thus the cleanest, quickest and simplest solution for plastics materials.

The object of the present invention is therefore that of providing a simple method for welding two different plastics materials. In this case, the connection between said different plastics materials by means of the weld seam is intended to be as stable as possible and long-lasting.

It has surprisingly been found that this object is achieved by a method for welding two different plastics materials using a primer, the two plastics materials to be joined have a weighted quadratic distance of the Hansen parameter (Rₐ)² from one another of more than 22 MPa, and the primer contains a polymer that has a weighted quadratic distance of the Hansen parameter (Rₐ)² from the two plastics materials to be joined of less than 22 MPa.

It has surprisingly been found that, by selecting the plastics materials and the primer on the basis of the weighted quadratic distance of the Hansen parameter (Rₐ)², the primer can be selected such that the two different plastics materials can be welded together. Using a corresponding primer makes it possible to achieve particularly stable and non-ageing connections between the plastics materials when welding two different plastics materials.

The weighted quadratic distance of the Hansen parameter (Rₐ)² is determined according to the following formula:

(Rₐ)²=4(Δδ_{D})²+(Δδ_{P})²+(Δδ_{H})²

In this formula, δ_{D} is the Hansen parameter for the dispersion forces, δ_{P} is the Hansen parameter for the polarity, and δ_{H} is the Hansen parameter for the hydrogen bridge bonds. Δδ_{D}, Δδ_{P} and Δδ_{H} in each case denote the differences of these Hansen parameters for the plastics materials or polymers to be compared, e.g. Δδ_{D}=(δ_{D1}−δ_{D2}) of polymers 1 and 2. The values of the individual Hansen parameters δ_{D}, δ_{P} and δ_{H} for the relevant plastics materials or polymers are determined according to the book “Hansen Solubility Parameters: A User's Handbook” by Charles M. Hansen (second edition; Taylor & Francis Group; 2007; ISBN-10 0-8493-7248-8). A number of values for individual polymers can already be found in this source. According to the method described in this book, the Hansen parameters can preferably be obtained from the accompanying database using the program HSPIP (4th edition 4.1.07), or, if this is not available, can be determined using the incorporated “DIY” functionality of the program, preferably using the accompanying neural network, as described in the “help” section. The HSPIP program is available from the company Steven Abbott TCNF Ltd.

The plastics materials to be joined are two different plastics materials which can, in principle, be selected from all known plastics materials provided that the plastics materials to be joined have a weighted quadratic distance of the Hansen parameter (Rₐ)² from one another of more than 22 MPa, preferably of more than 25 MPa, in particular of more than 30 MPa, particularly preferably of more than 35 MPa. When (Rₐ)² corresponds, the two plastics materials cannot be mixed with one another and are therefore incompatible, as a result of which welding of the two plastics materials is not possible without further auxiliary agents or is possible only with difficulty.

The plastics materials to be joined are preferably each based at least on a polymer, i.e. a polyamide plastics material is based on a polyamide polymer. More than 80 wt. %, in particular more than 90 wt. %, preferably more than 95 wt. %, particularly preferably more than 98 wt. % of the plastics material to be joined preferably consists of this polymer or the polymer mixture, based in each case on the polymer content of the plastics material to be joined (total plastics material without fillers). In addition to the polymer, the plastics material can also contain further components, e.g. fillers such as glass fibers, pigments, mineral particles, dyes, rheology auxiliary agents, release aids or stabilizers. The plastics material to be joined preferably consists to more than 40 wt. %, in particular more than 60 wt. %, preferably more than 70 wt. %, preferably more than 90 wt. % of this polymer, based in each case on the total plastics material (including fillers). The plastics materials preferably have a content of this polymer of 50-90 wt. %, in particular 60-80 wt. %, based in each case on the total plastics material (including fillers).

The plastics materials to be joined and/or the polymers on which these plastics materials are based can be selected from the following: The plastics materials are preferably thermoplastics, the following being mentioned by way of example as suitable thermoplastic polymers: polyoxyalkylenes, polycarbonates (PC), polyesters such as polybutylene terephthalate (PBT) or polyethylene terephthalate (PET), polyolefins such as polyethylene or polypropylene, poly(meth)acrylates, polyamides, vinyl aromatic (co)polymers such as polystyrene, impact-modified polystyrene such as HI-PS, or ASA, ABS or AES polymers, polyarylene ethers such as polyphenylene ether (PPE), polysulfones, polyphenylene sulfides (PPS), polyurethanes, polylactic acids, halogen-containing polymers such as polyvinyl chloride (PVC), polymers containing imide groups, cellulose esters, silicone polymers and thermoplastic elastomers. Mixtures of different thermoplastic polymers can also be used as materials for the plastics molded parts. These mixtures can be single-phase or multiphase polymer blends. The molded parts to be interconnected can consists of identical or different thermoplastic polymers or thermoplastic polymer blends, preferably the plastics materials have thermoplastic polymer as the main component, in particular consist to more than 40 wt. %, in particular to more than 60 wt. %, preferably to more than 70 wt. %, preferably to more than 90 wt % of said one thermoplastic polymer, based in each case on the polymer content of the plastics materials, in particular based in each case on the total plastics material (including fillers).

Polyamide plastics materials, for example, as suitable as plastics materials to be joined. The polyamide plastics material is preferably a thermoplastic polyamide. The amide-based thermoplastic polymers included, for example, polyamide 6, a homopolymer of epsilon-caprolactam (polycaprolactam); polyamide 11, a polycondensate of 11-Aminoundecanoic acid poly(11-aminoundecanamide); polyamide 12, a homopolymer of omega-lauryl lactam (polylauryl lactam); polyamide 6.6, a homopolycondensation of hexamethylenediamine and adipic acid (polyhexamethylene adipamide); polyamide 6.10, a homopolycondensation of hexamethylenediamine and sebacic acid (poly(hexamethylene sebacamide)); polyamide 6.12, a homopolycondensation of hexamethylenediamine and dodecanedioic acid (polyhexamethylene dodecanamide), or polyamide 6-3-T, a homopolycondensation of trimethylhexamethylenediamine and terephthalic acid (polytrimethylhexamethylenediamine), poly(p-phenylene terephthalamide) or poly(m-phenylene terephthalamide) of phenylenediamine and terephthalic acid, polyphthalamides (PPA) of different diamines and terephthalic acid, and mixtures thereof.

Optically transparent polyamides include monocrystalline polyamides containing linear aliphatic dicarboxylic acids and cyclo-aliphatic diamines, amorphous polyamides containing linear aliphatic dicarboxylic acids and cyclo-aliphatic diamines and optionally lactams or amino acids, amorphous polyamides containing terephthalic acid and cyclo-aliphatic or branched aliphatic diamines and optionally lactams or amino acids, or amorphous polyamides containing isophthalic acid and cyclo-aliphatic or linear or branched aliphatic diamines and optionally lactams or amino acids. Suitable optically transparent polyamides are, for example, amides of dodecanedioic acid and a mixture of isomers of 4,4′-diaminodicyclohexylmethane, of terephthalic acid and the mixture of isomers of 2,2,4- and 2,4,4-trimethylhexamethylenediamine, of dodecanedioic acid and the mixture of isomers of 3,3′-dimethyl-4,4′-di(aminocyclohexyl)-methane, of lauryl lactam, isophthalic acid and the mixture of isomers of 3,3′-dimethyl-4,4′-di(aminocyclohexyl)-methane or of tetradecanedioic acid and the mixture of isomers of 3,3′-dimethyl-4,4′-di(aminocyclohexyl)-methane or of epsilon-caprolactam or omega-lauryl lactam.

Preferred polyamides are selected from the group consisting of polyamide 6, polyamide 6.6, polyamide 6.10, polyamide 6.12, polyamide 10.10, polyamide 11, polyamide 12, polyamide 10.12, polyphthalamides, optical transparent polyamides or mixtures based on said polyamides. Particularly preferred polyamides are selected from polyamide 6, polyamide 6.6, polyamide 12, polyphthalamides, optically transparent polyamides and the mixtures thereof, in particular polyamide 6, polyamide 6.6 and the mixtures thereof.

Poly(meth)acrylate is a synthetic, preferably transparent, thermoplastic. Preferred poly(meth)acrylates are made up of 50 to 100 wt. %, in particular 70 to 100 wt. % acrylate and/or methacrylate, the (meth)acrylate units preferably being esterified with a C1 to C12 alkyl functional group, in particular C1-C4, preferably methyl functional group. The written form poly(meth)acrylate indicates that the polymer is made up of acrylate and/or methacrylate. That is to say that the written form (meth)acrylate indicates that it may be both an acrylate and a methacrylate. It is preferable in particular for the poly(meth)acrylate to be a polymethyl methacrylate (PMMA, colloquially also known as acrylic glass or Plexiglas). Preferred polymethyl methacrylates are made up of 50 to 100 wt. %, in particular 70 to 100 wt % methyl methacrylate.

Primarily, (meth)acrylic acid, in particular acrylic acid, and the alkyl esters thereof having 1 to 12 carbon atoms, in particular 1 to 4 carbon atoms in the alkyl functional group, and acrylo and/or methacrylonitrile, acryl and/or methacrylamide, styrene and/or maleic acid anhydride are possible as comonomers for making up the poly(meth)acrylate, in particular the polymethyl methacrylate. Thermoplastically and thermoelastically deformable plastics materials are preferred. Preferred thermoplastic polymethylmethacrylate plastics materials have weight-average molar masses (weight average Mw) of more than 50,000 g/mol, in particular more than 100,000 g/mol. The thermoplastic poly(meth)acrylate, in particular polymethylmethacrylate, plastics materials preferably have a weight-average molar mass (weight average Mw) of less than 2,000,000 g/mol, in particular less than 1,000,000 g/mol, preferably less than 500,000 g/mol. Particularly preferred thermoplastic poly(meth)acrylate, in particular polymethylmethacrylate, plastics materials have weight-average molar masses (weight average Mw) of from 50,000 g/mol to 250,000 g/mol, e.g. approximately 100,000 g/mol to approximately 180,000 g/mol for the injection molding.

Suitable polyolefin plastics are in particular thermoplastic polyolefin plastics. A polyolefin plastics material is based on polyolefin polymers such as homopolymers and copolymers of alpha-olefins. The polyolefin polymers can be selected from the group consisting of polyalphaolefin homopolymers based on ethylene, propylene and/or butylene, in particular homopolymers of ethylene or propylene, and polyalphaolefin copolymers based on ethene, propene, 1-butene, 1-hexene and 1-octene, in particular ethylene/alpha-olefin and propylene/alpha-olefin copolymers, preferably copolymers of ethylene or propene with 1-butene, 1-hexene and 1-octene, or a combination thereof. In particular, the polyolefin plastics are selected from polyethylene (in particular high-density/HD-polyethylene, medium-density/MD-polyethylene, low-density/LD-polyethylene, ultra high molecular weight/UHMW-polyethylene and linear low-density/LLD-polyethylene, preferably HD-polyethylene, MD-polyethylene or LD-polyethylene) and polypropylene plastics. The polyolefin plastics is particularly preferably a polypropylene plastics material.

The polyolefin polymers, in particular polypropylene polymers, preferably have a weight-average molar mass (weight average Mw) of more than 10,000 g/mol, in particular more than 20,000 g/mol, preferably more than 50,000 g/mol, particularly preferably more than 100,000 g/mol. The polyolefin polymers, in particular polypropylene polymers, preferably have a weight-average molar mass (weight average Mw) of less than 2,000,000 g/mol, in particular less than 1,000,000 g/mol, preferably less than 500,000 g/mol. Particularly preferred polyethylene polymers have a weight-average molar mass (weight average Mw) of from 50,000 g/mol to 1,000,000 g/mol, in particular of from 200,000 g/mol to 500,000 g/mol. Other preferred polyethylene polymers (UHMW-PE polymers) have a weight-average molar mass of more than 2,000,000 g/mol in particular of from 4,000,000 g/mol to 6,000,000 g/mol. Particularly preferred polyolefin polymers, in particular polypropylene polymers, have weight-average molar masses (weight average Mw) of from 50,000 g/mol to 250,000 g/mol.

Suitable polyester plastics materials are also known per se and described in literature. Preferred polyester plastics materials comprise a polyester having an aromatic ring in the main chain, which ring originates from an aromatic dicarboxylic acid. The aromatic ring may also be substituted, for example by a halogen such as chlorine or bromine, or by C1-C4-alkyl groups such as methyl, ethyl, i- or n-propyl groups or n-, or t-butyl groups. The polyesters can be prepared in a manner known per se by reacting aromatic dicarboxylic acids, the esters thereof or other ester-forming derivatives thereof, with aliphatic dihydroxy compounds. Naphthalenedicarboxylic acid, ortho-phthalic acid, terephthalic acid and isophthalic acid or the mixtures thereof are preferred dicarboxylic acids. Up to 30 mol. % of the aromatic dicarboxylic acid can be replaced by aliphatic or cyclo-aliphatic dicarboxylic acids such as adipic acid, azelaic acid, sebacic acid, dodecanedioic acid and cyclohexanedicarboxylic acid. Diols having 2 to 8 carbon atoms, in particular 1,2-ethanediol, 1,4-butanediol, 1,6-hexanediol, 1,4-hexanediol, 1,4-cyclohexanedimethanol and neopentyl glycol of the mixtures thereof are preferred aliphatic dihydroxy compounds. Polyalkylene terephthalates which can be derived from alkane diols having 2 to 6 C-atoms are particularly preferred polyesters.

The polyester plastics materials are preferably selected from the group consisting of polyethylene terephthalate (PET), polyethylene naphthalate, polybutylene naphthalate and polybutylene terephthalate (PBT) plastics materials and mixtures thereof, in particular polyethylene terephthalate (PET) and polybutylene terephthalate (PBT) plastics materials and mixtures thereof.

Suitable polycarbonate plastics materials are preferably thermoplastics that can formally be described as polyesters of carbonic acid. Polycarbonates can in principle be prepared by means of polycondensation of phosgene with diols, preferably bisphenols. Aromatic polycarbonates are preferred polycarbonates. Aromatic polycarbonates are those that are made up at least of an aromatic monomer. Preferred polycarbonate-plastics are polycarbonate-plastics based on bisphenol, in particular bisphenol A and bisphenol F. In the polycarbonates based on bisphenol, the diol component preferably consists to 50 wt. %, in particular to 70 wt. %, preferably to 90 wt. %, preferably to 100 wt. % of bisphenol, in particular bisphenol A and/or bisphenol F.

Plastics materials containing at least one vinyl aromatic polymer, in particular copolymer, of monomers selected from styrene, chlorostyrene, alpha-methylstyrene and para-methylstyrene are also suitable plastics materials. In smaller quantities, the vinyl aromatic copolymers can (preferably not more than 20, in particular not more than 8 wt. %) also comonomers such as (meth)acrylonitrile or (meth)acrylic acid esters be part of the make-up. Particularly preferred vinyl aromatic polymers are polystyrene, styrene-acrylonitrile copolymers (SAN), polystyrene methylmethacrylate (SMMA) and impact-modified polystyrene (HIPS=High Impact Polystyrene). Of course, mixtures of said polymers can also be used.

Most particularly preferred vinyl aromatic polymers are ASA, ABS and AES polymers (ASA=acrylonitrile-styrene-acrylic ester, ABS=acrylonitrile-butadiene-styrene, AES=acrylonitrile-EPDM-rubber-styrene). These high-impact vinyl aromatic polymers contain at least one rubber-elastic graft polymer and a thermoplastic polymer (matrix polymer). In general, a styrene/acrylonitrile polymer (SAN) is used as the matrix material. Preferably, graft polymers are used that contain, as the rubber, a diene rubber based on dienes such as butadiene or isoprene (ABS), an alkyl acrylate rubber based on alkyl esters of acrylic acid, such as n-butyl acrylate and 2-ethylhexyl acrylate, an EPDM rubber based on ethylene, propylene and a diene or mixtures of said rubbers or rubber monomers.

The weight-average molecular weight of said vinyl aromatic polymer is in particular of from 1,500 to 2,000,000 g/mol, preferably from 70,000 to 1,000,000 g/mol.

In addition, the plastics material may be a mixture of at least one polycarbonate and at least one vinyl aromatic polymer, preferably the vinyl aromatic polymer mentioned above. Said mixture preferably has a higher content of a polycarbonate than of the vinyl aromatic polymer, in particular SMMA, SAN, ASA, ABS and/or AES, preferably ABS. The ratio of the polycarbonate, in particular the aromatic polycarbonate, to the vinyl aromatic polymer, in particular SMMA, SAN, ASA, ABS and/or AES, preferably ABS, is preferably from 1:1 to 100:1, in particular 2:1 to 50:1, preferably 3:1 to 10:1

Polyoxyalkylene homopolymers or copolymers, in particular (co)polyoxymethylene (POM) are also suitable for preparing the plastics materials. In very general terms, said polymers comprise at least 50 mol. % of —CH2O repeating units in the polymer main chain. The homopolymers are generally prepared from formaldehyde or trioxane, by means of polymerization, preferably in the presence of suitable catalysts. Polyoxymethylene copolymers and polyoxymethylene terpolymers are preferred. The preferred polyoxymethylene (co)polymers have melting points of at least 150° C. and molecular weights (weight-average value) Mw in the range of from 5,000 to 200,000, preferably from 7,000 to 150,000 g/mol. End-group stabilized polyoxymethylene polymers having C—C bonds at the chain ends are particularly preferred.

Polyarylene ethers are preferably to be understood to be both polyarylene ethers per se and polyarylene ether sulfides, polyarylene ether sulfones or polyarylene ether ketones. The arylene groups thereof may be the same or different and represent, independently of one another, an aromatic functional group having 6 to 18 C-atoms. Examples of suitable arylene functional groups are phenylene, biphenylene, terphenylene, 1,5-naphthylene, 1,6-naphthylene, 1,5-anthrylene, 9,10-anthrylene or 2,6-anthrylene. Of said groups, 1,4-phenylene and 4,4-biphenylene are preferred. Said aromatic functional groups are preferably not substituted. They may, however, carry one or more substituents.

Furthermore, polyurethanes, polyisocyanurates and polyureas are suitable materials for preparing the plastics molded parts. Flexible, semi-rigid or rigid, thermoplastic or cross-linked polyisocyanate polyaddition products, for example polyurethanes, polyisocyanurates and/or polyureas, are generally known. The preparation thereof has been widely described, and is generally carried out by reacting isocyanates with compounds that react with isocyanates in generally known conditions. The reaction is preferably carried out in the presence of catalysts and/or auxiliaries.

The aromatic, aryl-aliphatic, aliphatic and/or cyclo-aliphatic organic isocyanates that are known per se, preferably diisocyanates, are possible as isocyanates.

Generally known compounds having a molecular weight of from 60 to 10,000 g/mol and a functionality with respect to isocyanates of from 1 to 8, preferably 2 to 6 (in the case of thermoplastic polyurethanes, functionality of approximately 2), for example polyols such as polyether polyols, polyester polyols and polyether polyester polyols having a molecular weight of from 500 to 10,000 g/mol and/or diols, triols and/or polyols having molecular weights of less than 500 g/mol can be used as compounds that react with isocyanates.

Polylactide, i.e. polymers of lactic acid, are known per se and can be prepared according to methods that are known per se.

As well as polylactides, co- or block copolymers based on lactic acid and further monomers can also be used. Linear polylactides are usually used. However, branched lactic acid polyesters can also be used. Multifunctional acids or alcohols, for example, can be used as the branching agent.

Polymers of vinyl chloride, for example, in particular polyvinylchloride (PVC) such as, rigid PVC and flexible PVC, and copolymers of vinyl chloride, such as uPVC molding compounds, are suitable halogen-containing polymers. Furthermore, fluoropolymers, in particular polytetrafluoroethylene (PTFE), TetraFluorEthylene-Perfluorpropylene copolymers (FEP), copolymers of tetrafluoroethylene with perfluoroalkyl vinyl ether, ethylene tetrafluoroethylene copolymers (ETFE), polyvinylidene fluoride (PVDF), polyvinyl fluoride (PVF), polychlorotrifluoroethylene (PCTFE), and ethylene chlorotrifluoroethylene copolymers (ECTFE) are possible.

Polymers containing imide groups are in particular polyimides, polyetherimides and polyamide-imides.

Suitable cellulose esters are, for example, cellulose acetate, cellulose acetate butyrate and cellulose propionate.

In addition, silicone polymers are also possible as thermoplastic polymers. Silicone rubbers, in particular, are suitable. These are generally polyorganosiloxanes that comprise groups capable of cross-linking reactions.

Finally, the compound class of the thermoplastic elastomers (TPE) can also be used. TPEs can be processed in the manner of thermoplastic polymers but have rubber-elastic properties. TPE block copolymers, TPE graft copolymers and segmented TPE copolymers consisting of two or more monomer units are suitable. Particularly suitable TPEs are thermoplastic polyurethane elastomers (TPE-U or TPU), styrene-oligo block copolymers (TPE-S) such as SBS (styrene-butadiene-styrene block copolymer) and SEBS (styrene-ethylene-butadiene-styrene block copolymer, which can be obtained by hydrogenating SBS), thermoplastic polyolefin elastomers (TPE-O), thermoplastic polyester elastomers (TPE-E), thermoplastic polyamide elastomers (TPE-A) and in particular thermoplastic vulcanizates (TPE-V).

Various embodiments will be described in the following which are preferred either individually or in combinations of two or more: Preferably, none of the plastics materials to be joined consists of a polyoxyethylene. Preferably, none of the plastics materials to be joined consists of a polycarbonate (PC). Preferably, none of the plastics materials to be joined consists of a polybutylene terephthalate (PBT) and/or polyethylene terephthalate (PET), in particular polyester. Preferably, none of the plastics materials to be joined consists of a polyethylene and/or polypropylene, in particular polyolefin. Preferably, none of the plastics materials to be joined consists of a polyamide. Preferably, none of the plastics materials to be joined consists of polystyrene, in particular of a vinyl aromatic (co)polymer. Preferably, none of the plastics materials to be joined consists of an ASA, ABS or AES polymer. Preferably, none of the plastics materials to be joined consists of a polyarylene ether. Preferably, none of the plastics materials to be joined consists of a polysulfone. Preferably, none of the plastics materials to be joined consists of a polyphenylene sulfide. Preferably, none of the plastics materials to be joined consists of a polyurethane. Preferably, none of the plastics materials to be joined consists of a polylactide. Preferably, none of the plastics materials to be joined consists of a halogen-containing polymer. Preferably, none of the plastics materials to be joined consists of a polymer containing imide groups. Preferably, none of the plastics materials to be joined consists of a cellulose ester. Preferably, none of the plastics materials to be joined consists of a silicone polymer. Preferably, none of the plastics materials to be joined consists of a thermoplastic elastomer.

The Hansen parameters for the above-mentioned polymers, from which the plastics materials to be joined can be prepared, are either known or can be determined, as set out above. In order to determine the weighted quadratic distance of the Hansen parameter (Rₐ)², the following formula, as defined above, can be used:

(Rₐ)²=4(Δδ_{D})²+(Δδ_{P})²+(Δδ_{H})²

For the different plastics materials to be joined, the different polymers of which the relevant plastics materials consist should have a weighted quadratic distance of the Hansen parameter (Rₐ)² of more than 22 MPa, preferably of more than 25 MPa, in particular of more than 30 MPa, particularly preferably of more than 35 MPa.

A further essential part of the invention is the use of at least one primer, preferably precisely one primer. The primer contains at least one first polymer which has a weighted quadratic distance of the Hansen parameter (Rₐ)² from the two plastics materials to be joined, in particular from the polymers on which the plastics materials are based, of less than 22 MPa, in particular of less than 17 MPa, preferably of less than 15 MPa, particularly preferably of less than 12 MPa. Since (Rₐ)² assumes corresponding values, the polymer of the primer is compatible with and can be mixed with the plastics materials to be joined and/or the polymers thereof, the compatibility of the individual components being better the smaller the value of (Rₐ)². Particularly stable and durable welded connections can thus be achieved.

The primer is a welding auxiliary agent that is preferably applied, as a pretreatment layer, to at least one of the substrate surfaces to be welded, in the region of the joining zone. The primer is not to be understood as an adhesive, cleaning agent or similar, but instead the primer is an auxiliary agent for welding, as a result of which the join partners are made mutually compatible in the joining zone (or welding zone), and thus an integrally bonded and frictional connection is achieved in the joining zone, upon joining, between the substrates to be welded.

Using a corresponding primer that contains a polymer according to the invention makes it possible for the different plastics materials to be made compatible in the join seam upon welding, and a stable and lasting connection is thus achieved. If a corresponding primer is not used, no or only very low strengths of the welded connection can be achieved. Preferably, the joined substrates have a tensile strength of more than 2 MPa, in particular more than 5 MPa, preferably more than 7 MPa. The tensile strength is determined at a traction speed of 5 mm/s, the samples to be measured having a geometry of 130 mm×68 mm×3 mm being welded end-to-end to the 130 mm×3 mm surface, using the primer.

All the polymers already mentioned above for the plastics materials are possible as suitable polymers for the primer.

Various embodiments will be described in the following which are preferred either individually or in combinations of two or more: Preferably, the primer is substantially free of polyoxyalkylenes. Preferably, the primer is substantially free of polycarbonates (PC). Preferably, the primer is substantially free of polybutylene terephthalates (PBT) and/or polyethylene terephthalates (PET). Preferably, the primer is substantially free of polyethylene and/or polypropylene, in particular polyolefins. Preferably, the primer is substantially free of polyamides. Preferably, the primer is substantially free of polystyrene, in particular a polystyrene consisting of a vinyl aromatic (co)polymer. Preferably, the primer is substantially free of ASA, ABS and/or AES polymers. Preferably, the primer is substantially free of polyarylene ethers. Preferably, the primer is substantially free of polysulfones. Preferably the primer is substantially free of polyphenylene sulfides. Preferably the primer is substantially free of polyurethanes. Preferably the primer is substantially free of polylactides. Preferably, the primer is substantially free of halogen-containing polymers. Preferably the primer is substantially free of polymers containing imide groups. Preferably the primer is substantially free of cellulose esters. Preferably the primer is substantially free of silicone polymers. Preferably the primer is substantially free of thermoplastic elastomers. The term “substantially free of” is understood, according to the invention, to mean that the primer contains less than 5 wt. %, preferably less than 1 wt. %, most particularly preferably less than 0.1 wt. % of the relevant substances, in particular does not contain the relevant substances.

In addition to the polymer according to the invention, the primer can preferably also contain at least one further polymer which is different from the first polymer according to the invention, in particular in terms of the polymer structure thereof. The at least one further polymer is preferably compatible with at least one of the two plastics materials to be welded and with the first polymer according to the invention in the primer. The further polymer preferably has a weighted quadratic distance of the Hansen parameter (Rₐ)², in particular from the two plastics materials to be joined and in particular also from the first polymer according to the invention mentioned above, of less than 22 MPa, in particular of less than 17 MPa, preferably of less than 15 MPa, particularly preferably of less than 12 MPa.

The content of the further polymer on the primer is preferably 1-40 wt. %, in particular 5-30 wt. %, particularly preferably 10-20 wt. %, based in each case on the total weight of the primer. The content of the further polymer on the polymer content of the primer is preferably 5-70 wt. %, in particular 20-60 wt. %, particularly preferably 30-50 wt. %, based in each case on the total polymer content of the primer (primer without solvents and without fillers). In a preferred embodiment, the primer does not contain a further polymer, but instead comprises just the first polymer according to the invention.

In a preferred embodiment, the first polymer according to the invention contained in the primer, in particular every polymer in the primer, preferably the primer, is substantially free of maleic acid anhydride groups. In a further preferred embodiment, the first polymer according to the invention contained in the primer, in particular every polymer in the primer, preferably the primer, is substantially free of maleic acid anhydride groups and/or amine groups, in particular substantially free of acid groups, acid anhydride groups, amine groups and/or hydroxyl groups, preferably substantially free of acid groups, acid anhydride groups, hydroxyl groups, thiol groups, amine groups, epoxide groups and/or isocyanate groups, preferably substantially free of any reactive groups. The groups described above are to be understood as groups that are present incorporated by polymerization/reacted into the polymer so as to still be free and in a form that is reactive under the welding conditions, such as free acid or OH groups. The term “substantially free of” is understood, according to the invention, to mean that the first polymer according to the invention contained in the primer, in particular every polymer in the primer, preferably the primer, contains less than 1 wt. %, preferably less than 0.1 wt. %, most particularly preferably less than 0.01 wt. %, most particularly preferably none of said groups.

In addition to the first polymer according to the invention and the further polymer, the primer can also contain a solvent, in particular an organic solvent. The primer preferably has a solvent content of 10-90 wt. %, in particular 50-85 wt. %, particularly preferably 60-80 wt. %, based in each case on the total weight of the primer.

All conventional solvents, such as water, alcohols, ketones such as methyl isobutyl ketone (MIBK) or cyclohexanone (CH), ethers such as diethyl ether or tetrahydrofuran (THF), esters such as ethyl acetate, or carbonates such as dimethyl or dipropyl carbonate, toluene, xylol or mixtures thereof are suitable solvents.

In a preferred embodiment, the primer contains organic solvents. Particularly preferred solvents are solvents having a vapor pressure at 20° C. of from 1 to 600 hPa, in particular 2 to 200 hPa, particularly preferably 5 to 20 hPa. In this case, solvents having a corresponding vapor pressure have been found to be particularly advantageous for minimizing or preventing bubble formation in the primer layer upon evaporation. Particularly preferably the primer contains a solvent selected from tetrahydrofuran, methyl isobutyl ketone, cyclohexanone and mixtures thereof, particularly preferably the primer contains tetrahydrofuran or a mixture of methyl isobutyl ketone and cyclohexanone. If a mixture of methyl isobutyl ketone and cyclohexanone is used as the solvent, said mixture preferably contains 10-50 wt. %, in particular 20-35 wt. % cyclohexanone, based in each case on the total solvent mixture.

If organic solvents are used, the total polymer content of the primer is preferably 10-90 wt. %, in particular 15-50 wt. %, particularly preferably 20-40 wt. %, based in each case on the total weight of the primer. The total polymer content corresponds to the content of all the polymers used in the primer, in particular the copolymers according to the invention and the further polymers described above.

In another preferred embodiment the primer is present in the form of an aqueous dispersion or emulsion. In this case, the polymer according to the invention and, if present, the further polymers, are emulsified or dispersed in water. In this case, the total polymer content of the primer is preferably 5-90 wt. %, in particular 20-70 wt. %, particularly preferably 30-55 wt. %, based in each case on the total weight of the primer. For the aqueous dispersion/emulsion, it is advantageous for the polymer component to consist substantially of only the polymer according to the invention and the optionally present further polymer mentioned above, in particular only the polymer according to the invention. The term “substantially of” is understood, according to the invention, to mean that the polymer component consists of more than 95 wt. %, preferably more than 97 wt. %, most particularly preferably more than 99 wt. % of the polymer according to the invention and the optionally present further polymer mentioned above, in particular consists only of the polymer according to the invention.

In another preferred embodiment, the primer is substantially free of solvents.

In addition to the copolymer according to the invention, the further polymer mentioned above, and a solvent, the primer may contain further components such as fillers, (fluorescent) dyes and pigments, rheological auxiliary agents, defoaming agents, wetting agents, stabilizers or plasticizers. However, apart from dye and pigments, the primer is preferably substantially free of further components, in particular substantially free of any other components. The term “substantially free of” is understood, according to the invention, to mean that the primer contains less than 5 wt. %, preferably less than 1 wt. %, most particularly preferably less than 0.1 wt. % of the relevant substances, in particular does not contain the relevant substances.

In the method according to the invention for welding two different plastics materials using a primer, the two plastics materials to be joined have a weighted quadratic distance of the Hansen parameter (Rₐ)² from one another of more than 22 MPa, and the primer contains a polymer that has a weighted quadratic distance of the Hansen parameter (Rₐ)² from the two plastics materials to be joined of less than 22 MPa.

In this method, the primer functions as an auxiliary agent for welding the two different plastics materials, by melting in each case. The compatible primers used make it possible to produce compatibility between the two join partners, as a result of which a stable and lasting integrally bonded connection between the two plastics materials can be produced.

The primer can be applied to the surface of one or both join partners using a wide range of methods. Thus, for example, said primer can be applied using a metering device, using a needle and metering robot, by means of injection molding, by means of extrusion, by means of film coating, by means of application as a hot melt, by means of spraying, by means of spreading, or by means of dipping.

When applying the primer, said primer can be applied either to just one surface or to both surfaces of the substrates to be welded. The primer is preferably applied to just one surface. In the case of welding using a film, the film must be laid between the substrates.

In the case of the primer containing a solvent, after being applied to one or both surfaces, the primer is preferably dried until the solvent has evaporated to such an extent that a non-sticky, dimensionally stable primer layer is achieved. In particular, the primer is weldable after just a few seconds and for a period of up to several weeks. After being applied, the primer is preferably dried for at least one hour, preferably for at least 12 hours.

The application to one or both surfaces of the substrates to be welded is preferably carried out such that the primer has a layer thickness of from 1 μm to 5,000 μm, in particular 10-3,000 μm, preferably 50-1,000 μm, particularly preferably 100-500 μm. If a solvent was contained in the primer, the layer thickness refers to the primer that has been dried of the solvent.

After the primer has been applied to one or both surfaces of the substrates to be welded, and optionally after the primer has dried, the substrates to be welded can be interconnected using a conventional welding method. Welding of plastics materials is usually carried out by means of local plasticization of the join partners in the joining plane, and joining under pressure. The process parameters should be selected such that pronounced squeezed flowing of the melt results in optimum connection of the join partners in the joining plane. Heating can be carried out by means of convection, contact heating, radiation or friction. The different energy input for plasticization can occur in a range of ways and has resulted in different processes for welding plastics materials.

Suitable welding methods are, for example:

Hot gas welding [HG]

Convective heating using a hot gas stream, in general air, two-stage process

Hot plate welding [HP]

Contact heating, two-stage process

Ultrasonic welding [US]

Heating by means of friction, a transverse wave in the ultrasound range leads to heating in the boundary layer, single-stage process

High frequency welding [HF]

Heating by internal friction, polar molecules align according to a high-frequency magnetic field, single-stage, only used for polar plastics materials and films

Friction welding [FRW]: Linear; Orbital; Spin; Angle

Heating by means of friction, single-stage process

Laser welding [LW]: contour, simultaneous, quasi-simultaneous, mask

Heating by means of radiation, coherent radiation, laser transmission welding, generally single-stage (two-stage is possible)

Infrared welding [IR]

Heating by means of radiation, incoherent radiation, two-stage

The welding methods set out above can optionally also be combined such as, for example, infrared welding and friction welding. The polyamide plastics material is particularly preferably welded to the poly(meth)acrylate plastics materials using a welding method selected from hot plate welding, thermal contact or thermal pulse welding, warm gas or hot gas welding, friction welding, microwave or induction welding. Laser butt or laser irradiation welding, infrared welding, ultrasonic welding and a combination thereof, in particular selected from hot plate welding, infrared welding, ultrasonic welding, friction welding and combinations thereof.

A method for integrally joining the two plastics materials using the primer that contains the following steps is particularly preferred:

providing the first plastics material comprising a first joining zone,

providing the second plastics material comprising a second joining zone,

preheating the first joining zone,

applying the primer to the preheated first joining zone, in particular in the case of solvent-free primers,

bringing the first joining zone provided with the primer into contact with the second joining zone,

integrally connecting the first joining zone to the second joining zone, in particular by using conventional plastics materials welding methods such as infrared welding, hot plate welding, hot gas welding, friction welding, ultrasonic welding.

In general, DIN 1910-3:1977-09 can be applied for welding plastics materials. Therefore, integral joining of thermoplastic plastics materials using heat and/or pressure can be understood in this context. The heating can be carried out for example on the basis of contact heating (welding using solid bodies), convection heating (welding using hot gas), radiation heating (welding using a beam), and heating by means of friction (welding by means of movement), as well as welding by means of electrical power.

In an advantageous development, a primer is used that is selected and matched to the method such that application thereof to a heated and/or hot joining zone at a temperature that is lower than the decomposition temperature of the polymers in the primer does not have any influence on the internal chemical cross-linking of the primer.

It is advantageous to preheat the first joining zone of the first plastics material. Auxiliary agents and techniques that are known to a person skilled in the art and are suitable for the purpose can be used for preheating. In particular, using hot gas or plasma is suitable for preheating. Preheating by means of radiation, in particular infrared radiation or laser radiation, is also conceivable. A heating element or a heated tool can also be used for preheating the first joining zone. Finally, preheating in an oven or in a heated room is also conceivable. Preheating the entire plastics material and thus also said joining zone is conceivable. Alternatively or in addition, however, it is also possible to preheat merely the joining zone itself.

In an advantageous development, the spacing of the heating device from the plastics material, in particular from the first joining zone to be preheated, in particular the spacing of the heat-emitting region of the heating device or the heat-emitting region of the heating device or the effective surface to be preheated of the heating device or the region of the heating device opposite the first joining zone is in a range of from 0.5 mm to 100 mm, preferably in a range of from 1 mm to 60 mm during preheating. It is also conceivable, alternatively, for heating to be carried out by and/or while making contact between in particular the first joining zone and the heating element of the heating device.

Selecting the plastics material for the first join partner and adjusting the method parameters to the first plastics material such that the first joining zone melts when preheated and that a melt layer is produced in the first joining zone upon preheating is a further advantage. In a particularly preferred embodiment, the thickness of the melt layer is preferably in the range of from 0.05 mm to 6 mm, particularly preferably in the range of from 0.1 mm to 5 mm. A melt layer of this kind can result in better adhesion and/or diffusion and/or interaction of the molecules and, in conjunction with a specific flow, to an improved connection layer. If the boundary layer of the first plastics material is in the molten state interactions as far as chemical bonding with the primer may occur. The melt layer can in particular be dependent on the component geometry and the relevant component design. Preferably, the method parameters are adjusted and/or selected such that no deformation of the components results. Temperature differences between the joining zone and the primer to be applied are preferably equalized using suitable means and/or method steps. In this case, it is conceivable in particular to preheat the primer in order to reduce the temperature difference between the preferably thermoplastic primer and the first joining zone. This can for example counteract the rapid cooling of the first joining zone between the process steps.

Optionally, the first joining zone is pretreated, preferably before the step of preheating the first joining zone. Alternatively or in addition, the second joining zone can also be pretreated. For example, cleaning using a solvent or a for example alkaline plastics cleaner is conceivable as a possible pretreatment. Mechanical pretreatment may also be used, in particular by means of scraping, polishing, brushing or radiation. Conceivable chemical pretreatments are in particular acid cleaning or using reactive gases. Moreover, the use of a thermal, chemical and/or physical pretreatment may prove expedient, in particular by means of gas flames or plasma arcs. Alternatively or in addition, electrical pretreatment by means of corona discharge can, during which the first joining zone and/or the second joining zone is subjected to electrical corona discharge in order that polar molecules, result at the corresponding surface. A further option is plasma treatment, preferably using a plasma nozzle, for pretreating the joining zone, in particular in order to activate and/or clean the corresponding surface. Nonetheless, coating by means of plasma may also prove expedient. A further option is flaming the joining zone in order to increase the surface tension in suitable plastics materials. A further type of pretreatment is radiation using UV rays, electron beams, radioactive rays or by means of a laser. Finally, pretreatment may also be carried out in the form of a coating, in particular by painting or using an adhesion promoter. It is also conceivable to pretreat the first plastics material or the joining zones of the first plastics material a longer time before preheating. It is thus conceivable, for example, to already carry out the pretreatment during the process of manufacturing the first plastics material, in order to be able to further process the pretreated plastics material in the method according to the invention.

It is conceivable for the primer to be applied in various ways. For example, and in particular in the industrial field, application using an automated application aid, in particular by means of a metering robot, is conceivable. In this case, said robot can be equipped with a needle and/or a height sensor in order to be able to carry out complex metering processes. The primer may also be applied by means of injection molding, in that the primer is plasticized in an injection molding machine and injected under pressure into the mold containing the first plastics material comprising the first joining zone. A film application is alternatively conceivable, a film first being prepared from the primer in a first by means of film blowing or flat film extrusion. Subsequently, the film can be cut into any desired shape, for example by means of a cutting or stamping method, and, following the mentioned preheating, can be applied, in a further step, to the first joining zone. In this case, it has been found to be expedient to use films/plates having a thickness in the range of 1 μm-5,000 μm. Further conceivable application possibilities are extrusion welding, during which the primer is present in the form of a welding wire or melted in an extruder and can be applied, in molten form, to the first joining zone. It is also possible for the primer to be provided in the form of a welding wire in order to make application by means of hot air welding possible. A further option is to apply the primer by means of a spraying method. Pretreatment and/or preheating and/or locally varied temperature control of the injection molding tool is also possible in the case of application during injection molding. Of course, other types of application that are known to a person skilled in the art and are suitable for the specific use are also conceivable.

Further heating or heating the first joining zone while the primer is being applied, in particular in order to prevent the temperature of the first joining zone from dropping between preheating and application of the primer is a further advantage. This can be carried out by means of the preheating method step described above which, for the sake of simplicity, can be continued during the application. Alternatively or in addition, additional heating, in particular by means of a further method step, is possible. It may thus prove to be expedient, for example, to simultaneously heat the first joining zone, for example by means of simultaneously exposing the first joining zone to radiation, forced convection, contact heating during primer application, in order to prevent the temperature of the first joining zone from dropping following the preheating.

In an advantageous development, the primer is applied such that a connection layer having a thickness in the range of from 1 μm to 5 mm, preferably in the range of from 10 μm to 3 mm, is arranged on the first joining zone. In this case, the thickness of the connection layer is to be understood as the material thickness of the connection layer on the first joining zone.

A further advantage is applying the primer to the first joining zone by means of a metering device while the first joining zone and the metering device are moved relative to one another, the first joining zone, to which the primer is applied, being preheated, prior to application of the primer, by means of a heating device while the first joining zone and the heating device are moved relative to one another, the primer being applied by means of the metering device when the first joining zone is in the preheated state.

In this case, it has been found to be particularly advantageous for the heating device to be moved past the first joining zone at a speed in the range of from 10 mm/min to 100 mm/min, preferably in the range of from 10 mm/min to 30 mm/min, during preheating.

It may further be advantageous for the heating device to precede the metering device, preferably at a defined and constant spacing. In particular, it is advantageous to carry out the method in such a way that the primer is applied to the first joining zone by means of a metering device while the metering device and the first joining zone are moved relative to one another in a range of from 10 mm/min to 100 mm/min, preferably in the range of from 10 mm/min to 30 mm/min, said joining zone to which the primer is applied being preheated, prior to application of the primer, by means of a heating device while the heating device and the first joining zone are moved relative to one another, the heating device preferably simultaneously preceding the metering device or a nozzle of the metering device for applying the primer at a time lag in the range of from 0.1-10 s.

In this case, it has been found to be particularly advantageous to use a coating unit consisting of the metering device and the heating device. In this case, a coating unit can in particular be understood to be a unit that provides a rigid connection between the heating device and the metering device, such that the heating device precedes the metering device preferably at a defined and constant spacing during the relative movement in order to ensure that the first joining zone is preheated immediately before the primer is applied. Of course, it is also conceivable, in this case, for the spacing to be adjustable or, in the case of convective preheating, for the volume flow and/or nozzle diameter of the medium to be adjusted in particular by means of suitable mechanically, electromechanically or pneumatically operated adjusters.

In contrast, the coating unit can also be understood to be a heating device and a metering device in the form of two entirely isolated or separate modules which, however, perform the same or substantially the same relative movement with respect to the plastics material in order to ensure that the location of application of the primer is preheated immediately before the primer is applied.

In an advantageous development, although the heating device and the metering device perform substantially the same primary relative movement or have substantially the same basic direction with respect to the plastics material, at least one of the two mentioned devices experiences an additional relative movement, in addition to said primary relative movement, with respect to the plastics material. Thus, for example, the heating device and/or the metering device can perform one or more secondary relative movements in addition to the primary relative movement during which, for example, the primer may also be applied. For example, in particular the heating device and/or the metering device can perform or experience a secondary relative movement that circles or meanders around the primary relative movement.

In this case, the plastics material on the one hand, or the heating device and the metering device or both devices together as the coating unit on the other hand, can be moved. In this case, it is possible for the heating device and the metering device or both devices together as the coating unit on the one hand, and the plastics material on the other hand, to be stationary or for the moving part thereof to be moved in a different direction in each case.

In an advantageous development, a primary relative movement takes place at a speed in a range of from 10 mm/min to 100 m/min, preferably in a range of from 10 mm/min to 30 m/min, such that for example, in particular also due to a suitable design of the heating device, the residence times of the plastics material within the heating surfaces of the heating device are as short as possible, in particular in a range of from 1 to 60 s. This can be understood to be a region or space around the heating device that influences the temperature in the sense of increasing the temperature, i.e. preheating, of the first joining zone of the first plastics material. It is thus possible to avoid too much heating and damage to the plastics material or degradation of the plastics material for example.

It may in addition prove to be advantageous, in particular in order to connect the metering device and/or the heating device to/into existing production lines, to equip the heating device with a bus interface, in particular for a PROFIBUS, or with a real-time ethernet interface.

After said primer has been applied, the second joining zone is brought into contact with the primer layer. In this case, it may prove to be expedient to fix the two plastics materials together, in particular by means of clamping devices or similar fixing auxiliary agents that are known to a person skilled in the art.

Of course, the second joining zone may optionally be pretreated prior to the step of bringing the second joining zone into contact with the primer layer. In this case, in particular all the above-described pretreatment techniques are conceivable. It is also conceivable for the second plastics material or the joining zones of the second plastics material to be pretreated a longer time before being brought into contact. It is thus conceivable, for example, to already carry out the pretreatment during the process of manufacturing the second plastics material, in order to be able to further process a pretreated plastics material in the method according to the invention. The pretreatment of the second plastics material may also include applying the primer to the second joining zone. In this case, it is preferably also conceivable to preheat the second joining zone prior to applying the primer. The above embodiments are also preferred here.

Bringing the second joining zone and the primer into contact, as described above, is followed by a joining process in which the treated and/or coated join partners are plasticized by means of a supply of heat and are integrally interconnected, preferably under the action of pressure. It is conceivable to use a heat supply by means of thermal conduction, for example by means of hot plate welding and/or thermal contact welding and/or thermal pulse welding; by means of friction, in particular ultrasonic, friction or high-frequency welding; microwave or induction welding; by means of convention, such as warm gas or hot gas welding; by means of radiation, for example infrared, laser butt or laser irradiation welding, or by means of a combination of two or more of said techniques, for this integral connection between the second joining zone and the primer.

This invention further relates to objects or products produced according to the method according to the invention.

Furthermore, this invention relates to the use of a primer according to the invention for welding two different plastics materials.

### EMBODIMENTS

Selected Material and Hansen Parameter

| | | δ_{D} [√MPa] | δ_{P} [√MPa] | δ_{H} [√MPa] |
|---|---|---|---|---|
| Plastic material | Polyamide 12 | 16.7 | 5 | 5 |
| 1 | | | | |
| Plastics material | Styrene-butadiene- | 17.5 | 3.35 | 0.75 |
| 2 | acrylate copolymer | | | |
| Primer-polymer | Phenylene ether | 16.6 | 3.1 | 2.7 |

For the two plastics materials polyamide 12 and styrene-butadiene-acrylate copolymer, a value of 23.3 MPa results for (Rₐ)² according to 4(δ_{D1}×δ_{D2})² (δ_{P1}−δ_{P2})²+(δ_{H1}−δ_{H2})².

For the primer-polymer phenylene ether and the plastics material 1, polyamide 12, a value of 8.9 MPa results for (Rₐ)².

For the primer-polymer phenylene ether and the plastics material 2, styrene-butadiene-acrylate copolymer, a value of 7.1 MPa results for (Rₐ)².

Using the primer-polymer phenylene ether made it possible for the two mentioned plastics materials to be made mutually compatible in order for said materials to be welded.

What is claimed is:

1. A method for welding two different plastics materials using a primer, characterized in that the two plastics materials to be joined have a weighted quadratic distance of the Hansen parameter (Rₐ)² from one another of more than 22 MPa, and the primer contains a polymer that has a weighted quadratic distance of the Hansen parameter (Rₐ)² from the two plastics materials to be joined of less than 22 MPa.

2. The welding method according to claim 1, characterized in that the two different plastics materials have a weighted quadratic distance of the Hansen parameter (Rₐ)² from one another of more than 25 MPa, in particular of more than 30 MPa, particularly preferably of more than 35 MPa.

3. The welding method according to claim 1, characterized in that the plastics materials to be joined in each case consist to more than 40 wt. %, in particular more than 60 wt. %, preferably more than 70 wt. %, preferably more than 90 wt. % of at least one polymer, based in each case on the total plastics material.

4. The welding method according to claim 1, characterized in that the polymer of the primer has a weighted quadratic distance of the Hansen parameter (Rₐ)² from the two plastics materials of less than 17 MPa, preferably of less than 15 MPa, particularly preferably of less than 12 MPa.

5. The welding method according to claim 1, characterized in that the primer contains a further polymer which has a weighted quadratic distance of the Hansen parameter (Rₐ)², preferably from one, in particular from the two, plastics materials to be joined and in particular also from the first polymer of the primer of less than 22 MPa, in particular of less than 17 MPa, preferably of less than 15 MPa, particularly preferably of less than 12 MPa.

6. The welding method according to claim 5, characterized in that the content of the further polymer on the primer is 1-40 wt. %, in particular 5-30 wt. %, particularly preferably 10-20 wt. %, based in each case on the total weight of the primer, or the primer does not contain any further polymer.

7. The welding method according to claim 1, characterized in that the polymer contained in the primer, in particular every polymer in the primer, preferably the primer, is substantially free of maleic acid anhydride groups and/or amine groups, in particular substantially free of acid groups, acid anhydride groups, amine groups and/or hydroxyl groups, preferably substantially free of acid groups, acid anhydride groups, hydroxyl groups, thiol groups, amine groups, epoxide groups and/or isocyanate groups, preferably substantially free of any reactive groups.

8. The welding method according to claim 1, characterized in that the primer contains at least one solvent, in particular at least one organic solvent, the primer preferably having a solvent content of 10-90 wt. %, in particular 50-85 wt. %, particularly preferably 60-80 wt. %, based in each case on the total weight of the primer.

9. The welding method according to claim 8, characterized in that the at least one solvent has a vapor pressure at 20° C. of from 1 to 600 hPa, in particular 2 to 200 hPa, particularly preferably 5 to 20 hPa, preferably the solvent is selected from the group of tetrahydrofuran, methyl isobutyl ketone, cyclohexanone and mixtures thereof.

10. An object produced according to a welding method according to claim 1.
